(19) United States
(12) Patent Application Publication
(10) Pub. No.: US 2006/0168410 A1
(43) Pub. Date: Jul. 27, 2006

(54) Systems and methods of merge operations of a storage subsystem

(76) Inventors: John J. Andruszkiewicz, Hollis, NH (US); Andrew C. Goldstein, Hudson, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/041,842

(22) Filed: Jan. 24, 2005

(51) Int. Cl. G06F 12/16

(52) U.S. Cl. 711/162

(57) ABSTRACT

A first computer is adapted to communicate with another computer and to a redundant storage subsystem external to the first computer. The first computer comprises memory comprising state information and a processor that receives a state from another computer. The received state is indicative of whether the other computer may perform write transactions to the redundant storage subsystem. The first computer's processor also determines whether to perform a data merge operation on the redundant storage subsystem based on the other computer's last received state prior to a failure of the other computer.

### BACKGROUND

In some systems, a plurality of host computers perform write transactions (“writes”) to a redundant storage subsystem. Redundant storage subsystems generally comprise one or more storage devices to which data can be stored in a redundant manner. For example, two or more storage devices may be configured to implement data “mirroring” in which the same data is written to each of the mirrored storage devices.

A problem occurs, however, if a host computer fails while performing the multiple writes to the various redundantly configured storage devices. Some of the storage devices may receive the new write data while other storage devices, due to the host failure, may not. A process called a “merge” can be performed to subsequently make the data on the various redundantly configured storage devices consistent. Merge processes are time consuming and generally undesirable, although necessary to ensure data integrity on a redundantly configured storage subsystem.

### BRIEF DESCRIPTION OF THE DRAWINGS

For a detailed description of exemplary embodiments of the invention, reference will now be made to the accompanying drawings in which:

FIG. 1 shows a system having a plurality of hosts coupled to a storage subsystem, each host storing state information in accordance with various embodiments of the invention;

FIG. 2 shows a block diagram of a host in accordance with various embodiments of the invention;

FIG. 3 shows a method implemented in at least one of the hosts in accordance with various embodiments of the invention;

FIG. 4 shows another method implemented in at least one of the hosts to determine whether to perform a merge operation in accordance with various embodiments of the invention; and

FIG. 5 shows an alternative embodiment of a system in which less than all hosts maintain state information.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

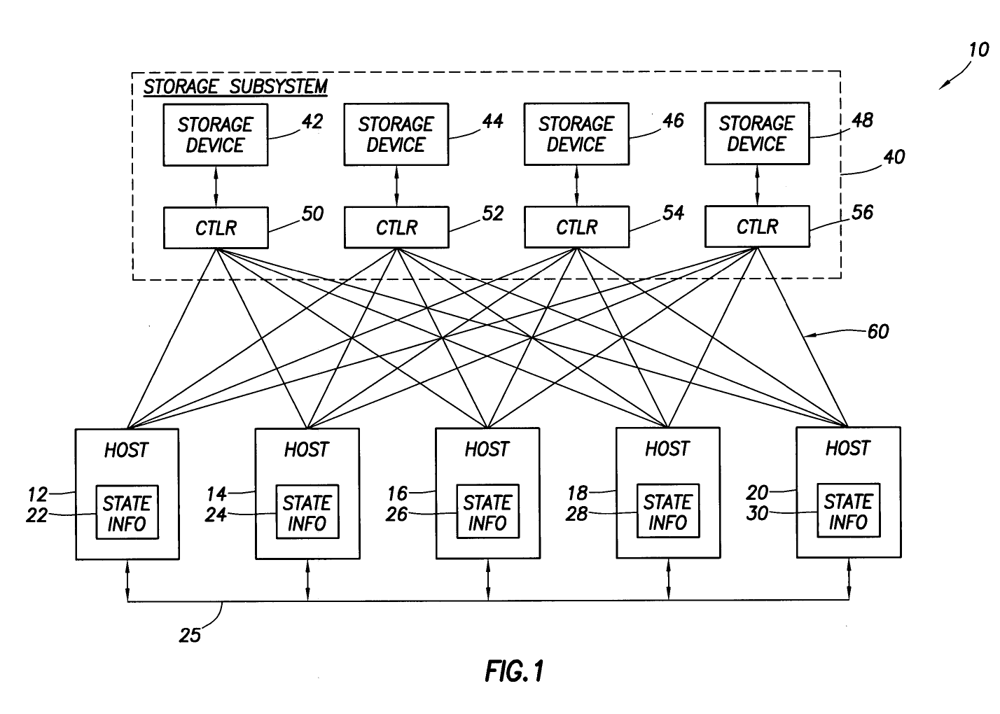

FIG. 1 shows a system 10 comprising a plurality of hosts coupled to a storage subsystem 40 by way of communication links 60. In the embodiment of FIG. 1, the system 10 comprise five hosts, hosts 12, 14, 16, 18, and 20, although in other embodiments, any number of hosts greater than one (i.e., two or more hosts) is acceptable. Each host 12-20 comprises a computer adapted to read data from and write data to the storage subsystem. Each host includes storage for “state information,” the use of which will be explained below. Host 12 includes state information 22, while hosts 14, 16, 28, and 20 include state information 24, 26, 28, and 30, respectively. The five hosts 12-20 use communication link 25 to transmit and receive messages.

The storage subsystem 40 comprises a plurality of redundantly configured storage devices. In the embodiment of FIG. 1, the storage system comprises four storage devices 42, 44, 46, and 48, although a different number (two or more) of storage devices is acceptable in other embodiments. Each storage device may comprise any suitable type of non-volatile storage. Examples include hard disk drives and optical read/write drives. A controller is provided for each storage device to control access to the associated storage device. Accordingly, controllers 50, 52, 54, and 56 are associated with storage devices 42, 44, 46, and 48, respectively.

In the embodiment of FIG. 1, each host 12-20 is configured to perform redundant write transactions (“writes”) to the various storage devices 42-48. For example, when host 12 performs a write to the storage subsystem 40, host 12 performs a write to each of the storage devices 42-48 to receive the data. Since all four storage devices 42-48 are redundantly configured, then host 12, as well as the other hosts, performs a write to each of the four storage devices. The communication links 60 illustrate that each host couples to each of the four storage devices. Different architectures and configurations are possible besides that shown in FIG. 1.

The redundant configuration of the storage system can be any suitable configuration. Exemplary configurations include Redundant Array of Independent Disk (“RAID”) configurations such as RAID0, RAID1+0, RAID1, etc. Examples of suitable configurations can be found in U.S. Pat. Nos. 6,694,479 and 6,643,822, both of which are incorporated herein by reference. The particular type of redundant storage configuration is not important to the scope of this disclosure.

In accordance with various embodiments of the invention, each host in FIG. 1 informs each of the other hosts as to a state associated with the informing host. The state information associated with each host generally indicates whether or not that host may perform writes to the storage subsystem 40. At least two states are possible. In a first state, the host precludes itself from performing writes to the storage subsystem 40. In this state, the host may or may not have any data to write to the storage subsystem, but at any rate, the host precludes itself from performing writes. This first state is also referred to as the “no pending write” (“NPW”) state. In a second state, the host may perform a write to the storage subsystem. In this state, the host may or may not actually have data to write to the storage subsystem, but write transactions can be performed by the host should the host have data to write. This second state is also referred as the “pending write” (“PW”) state.

A first host informs another host of the state of the first host in accordance with any suitable technique. For example, the first host can send a message over communication link 25 to the other host(s). The message may contain a state indicator value indicative of the state (PW or NPW) of the first host. In some embodiments, pre-defined messages may be used to communicate state information across communication link 25. In other embodiments, the state information may be communicated as part of other messages. In yet other embodiments, a single message may be used to communicate a change of state (from PW to NPW and vice versa). Further still, pre-defined “start NPW” and “stop NPW” messages can be issued to communicate state information to other hosts.

In the embodiment of FIG. 1, each host determines its state (PW or NPW) and informs the other hosts of that state. For example, host 12 may determine its state to be PW and informs the other hosts, hosts 14-20, accordingly. The other hosts 14-20 determine, from the PW state reported by host 12, that host 12 may be performing a write or may perform a write in the future. In effect, a host reporting its state as PW is that host's representation that a write may occur. Alternatively stated, the other hosts cannot rely on a PW host to not write to the storage subsystem. A host 12, however, may determine its state to be NPW and informs the other hosts of that state. The other hosts determine, from the NPW state reported by host 12, that host 12 is not and will not perform any writes while in the NPW state. The NPW state of host 12 is, in effect, a representation by host 12 that host 12 will not perform any writes to storage subsystem 40 until host 12 first changes its state back to PW, informs the other hosts of the state change back to PW, and receives their acknowledgment of that change of state. While host 12 is in the NPW state, the other hosts can rely on host 12 not to write to the storage subsystem. The state information from one host to the other hosts is communicated across the communication link 25 which may be any suitable type of bus or other communication link.

Each host in the system 10 communicates its state to the other hosts. The communication of the host information may be performed when each host changes its state, for example, from PW to NPW or NPW to PW. Each host 12-20 maintains state information of that host and the other hosts in the system and thus all of the state information 22-30 among the various hosts is the same, at least in some embodiments. In other embodiments, the state information for a particular host need not have the state of that particular host, rather only the state information associated with the other hosts as communicated in the manner described above.

The state information may be maintained as a data structure such as a bit map. Each bit in the bitmap corresponds to a particular host and indicates the state of that host. A bit value of “0” may designate the PW state while a bit value of “1” may designate the NPW state, or vice versa. Multiple bits may be used for each host to encode that host's state.

As described above, each host 12-20 contains state information which is representative of the write state of the hosts in the system. Additionally, when a host fails, the remaining operational hosts are informed of the failure, or otherwise detect the failure, and, based on the state information, each host can determine whether the failed host was in the PW or NPW state at the time of the failure and thus determine whether to cause a merge to be performed to ensure data consistency in the storage subsystem. Any of a variety of techniques can be used for a host to be informed or otherwise detect a failure of another host. For example, periodic “keep alive” messages can be exchanged between all hosts. When a specific host ceases to communicate “keep alive” messages for a predetermined period of time, it is considered as failed.

By way of example, if host 12 were to fail, host 14 can determine or be informed of the failure of host 12 and consequently examine state information 24 contained in host 24. From the state information 24, host 14 determines whether failed host 12 was in the PW or NPW state at the time of the failure. The last state recorded in state information 24 presumably reflects the state of host 12 at the time of its failure. If failed host 12 was in the PW state at the time of its failure, then host 14 determines that a merge operation should be performed to ensure data consistency. If, however, failed host 12 was in the NPW state at the time of its failure, then host 14 determines that a merge operation need not be performed. In the latter situation, because host 12 was not writing data to storage subsystem 40 at the time of the failure, host 12 could not have caused one or more of the storage devices to be written with different data than one or more other storage devices. As such, host 14 determines that a merge operation is not required. In some embodiments, each of the hosts (i.e., hosts 12-20) examines its own state information to determine whether a merge operation is to be performed. In this latter embodiment, when all operational hosts (14-20 in the example above) determine no merge process is to be performed, the system 10 avoids a merge process. If a host determines a merge process to be needed, a merge process is implemented. Any of a variety of merge techniques can be implemented such as that disclosed in U.S. Pat. No. 5,239,637, incorporated herein by reference.

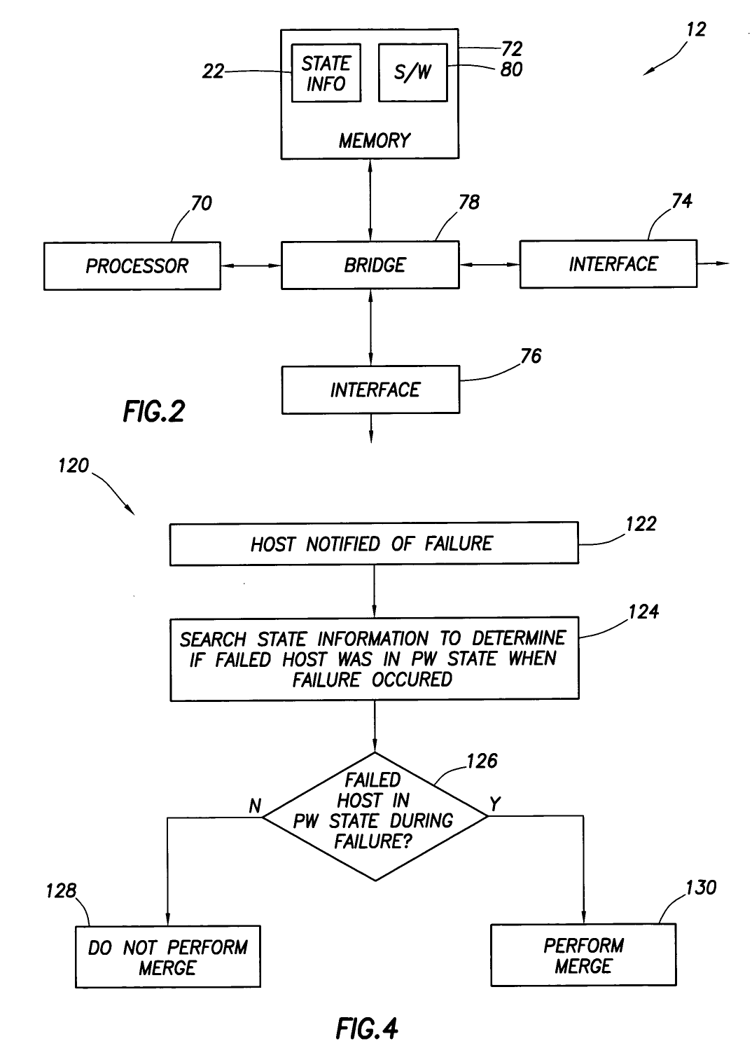

Referring now to FIG. 2, host 12 comprises a processor 70, memory 72, interfaces 74 and 76, and a bridge 78. The processor 70, memory 72, and interfaces 74, 76 all couple to bridge 78 as shown. Each of the other hosts 14-20 may have an architecture that is the same or similar to that shown in FIG. 2. The memory 72 contains one or more data structures and/or executable applications. One such data structure includes state information 22 as described above. Software 80 comprises one or more applications that may run on the processor 70 of host 12. Any of the software applications may require write and/or read operations associated with said storage subsystem 40. The software 80 may also include executable code that causes the processor 70 and the host to perform one or more of the functions described herein.

Referring now to FIG. 3, a method 100 is provided that is executable on any or all of the hosts 12-20. Beginning at 102, the host is assumed to be in the PW state. At 102, the host determines whether any writes are pending to be performed to the storage subsystem 40. If there are pending writes, the host at 104 continues to operate in its current state (which in FIG. 3 is assumed to be the PW state). If the host has no pending writes to be performed to the storage system, then control passes to 106. Any suitable technique can be used to determine whether any writes are pending. For example, a time threshold can be set and if a period of time corresponding to the time threshold has passed without the host having any writes to perform to the storage subsystem, the host can determine that there are no pending writes. Alternatively, a pointer may be maintained to keep track of the pending writes in, for example, a buffer. The host may determine that there are no pending writes if the pointer reaches a value indicative of the buffer having no more pending writes.

If there are no pending writes, then at 106 the host transmits a NPW message to one or more of the other hosts in the system 20 and the other hosts may respond with an acknowledgement of the NPW message. At 108, the host updates its own state information to reflect that its state is now the NPW state. The host then determines at 110 whether it has any pending writes to be performed. If no writes are pending, then the host continues to operate in the NPW state (112). The host repeatedly checks to determine whether it has any writes pending to be performed and when a write is pending (e.g., in accordance with techniques described above), control passes to 114 at which time the hosts transmits a PW message to one or more of the other hosts in the system 10. At 116, the host again updates its state information to reflect that the host is now in the PW state. In some embodiments, the host's update of its state information occurs after receiving acknowledgments from the PW message sent to other host(s). Control loops back up to decision 102 and control continues as described above. In accordance with at least some embodiments, a host will not report a state change from PW to NPW until all previous writes to storage subsystem 40 have completed successfully.

Thus, FIG. 3 provides a method in which each hosts remains in the PW state until the host, according to any desired criteria, determines that the host has no writes pending to be performed. When the host determines that it has no pending writes, the host transitions its state to the NPW state and informs all other hosts of its state transition. After the other hosts acknowledge this state transition, the host then continues operating in the NPW state until the host has one or more writes pending to be performed, at which time the host transitions back to the PW state and informs the other hosts of that state transition. In the embodiment of FIG. 1 all of the hosts 12-20 perform the method of FIG. 3, and thus each host is informed of the state of all the other hosts in the system.

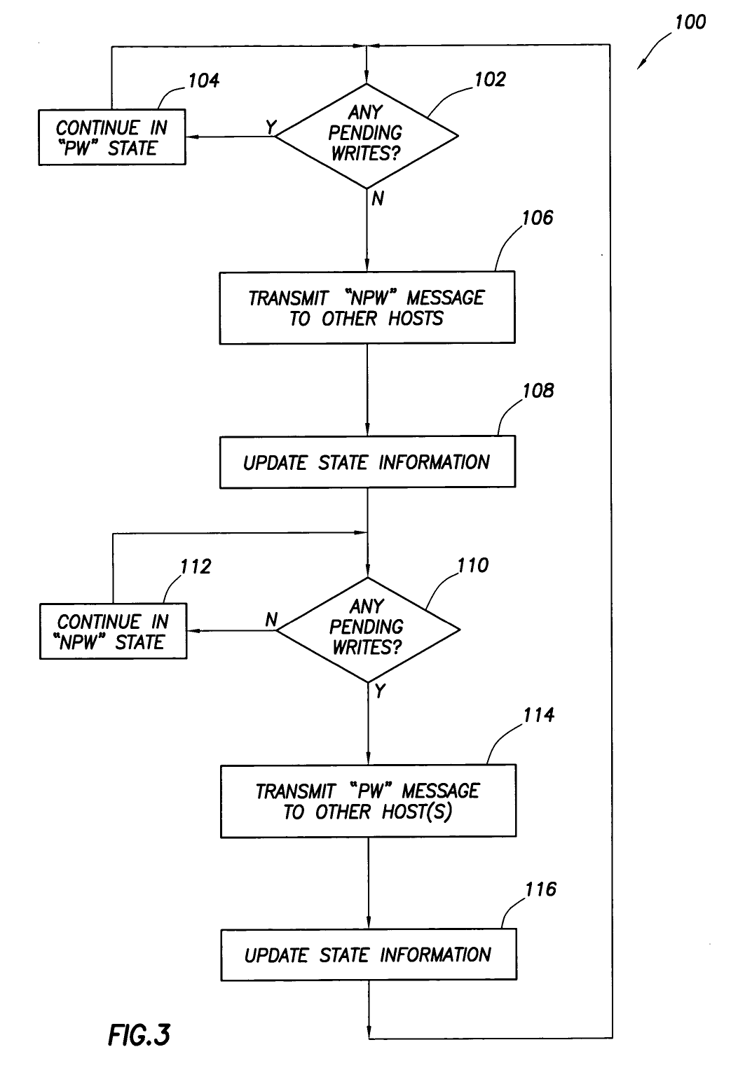

FIG. 4 shows a method 120 which describes the reaction of the system 10 upon failure of a host. Method 120 is performed by one or more of the remaining (i.e., non-failing hosts) in the system 10. The host is notified, or detects, of the failure of the failing host at 122. At 124, the host searches its state information to determine if the failed host was in the PW state when the failure occurred. At 126, the hosts determines the state of the failed host. If the host determines that the failed host was in the PW state upon in its failure, control passes to 130 in which a merge operation is performed or otherwise caused to be performed. If, however, a failed host was not in the PW state upon its failure (i.e., the host was in the NPW state), control passes to 128 in which a merge operation is precluded. As noted above, in some embodiments all of the non-failing hosts may perform the method 120 of FIG. 4. In other embodiments, fewer than all of the remaining, non-failing hosts perform method 120.

Each of the still operational hosts performs the method 120 of FIG. 4. In some embodiments, all operational hosts must reach the same conclusion as to whether a merge operation is to be performed. If unanimity cannot be reached, a default response is performed. That default response may to perform a merge. While time consuming, merges ensure data integrity. As a host concludes that a merge needs to be performed, that host sends a message over link 25 to the other hosts so informing the other hosts. If all other hosts are in agreement that a merge needs to be performed, then, in accordance with various embodiments, the host that first reported on link 25 the a merge needs to occur is elected to be the host to actually perform the merge. Messages can be passed back and forth on link 25 amongst the various hosts in any suitable manner culminating with the election of the host to control the merge operation. For example, the first host to conclude that a merge is to occur sends a message so indicating to the other hosts. As each such other host agrees with that assessment, each such host responds back on link 25 its agreement and acknowledging that the first host is permitted to perform the host. Once all such responses are received by the first host, and all are in agreement with the conclusion reached by the first host, the first to signal a need to perform a merge initiates the merge operation.

In other embodiments, fewer than all hosts need agree on the response (merge or no merge) to a failed host. Unanimity, however, amongst the hosts helps to ensure the integrity of the decision making process as to whether to perform a merge. For example, if only a single host were to make this decision and that host were malfunction while performing method 120 of FIG. 4, an erroneous decision may be reached, or no decision at all may be reached. Nevertheless, embodiments of the invention permit as few as one and as many as all of the operational hosts to perform method 120.

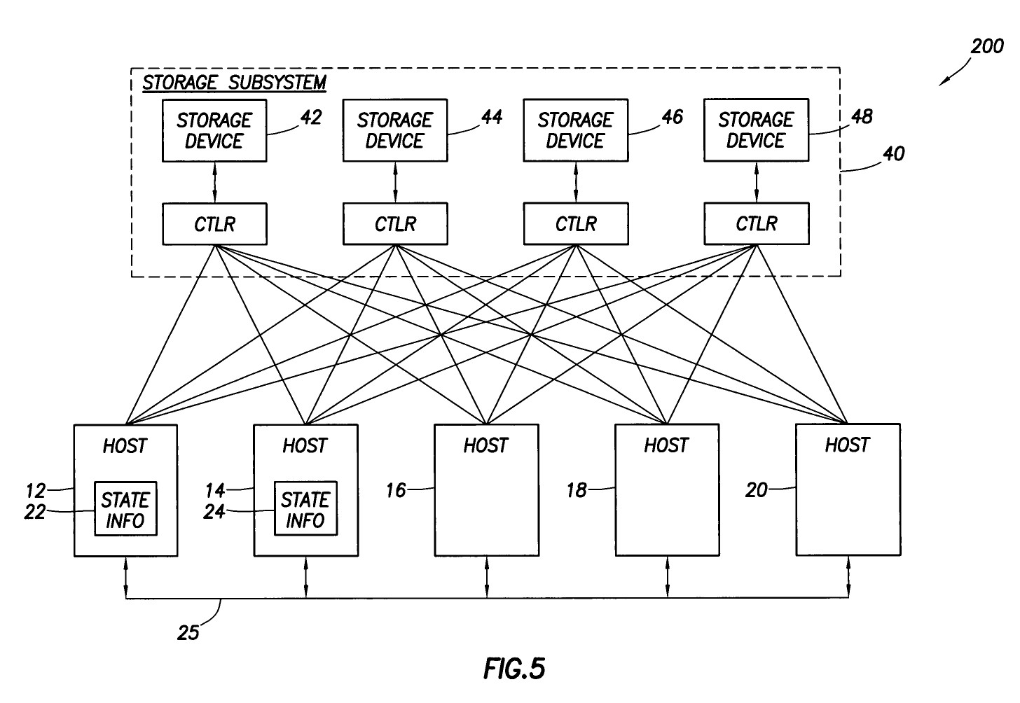

Referring now to FIG. 5, a system 200 is shown also comprising, as in FIG. 1, a plurality of hosts 12-20 coupled to a storage subsystem 40 which comprises a plurality of storage devices 42-48. For purposes of illustration, assume that only hosts 12 and 14 contain state information. Host 12 contains state information 22 and host 14 contains state information 24. The remaining hosts, host 16, 18, and 20 do not contain state information. FIG. 5 illustrates an embodiment in which not all hosts contain the state information described above. In the example of FIG. 5, two of the five hosts have state information. In general, only one or more of the hosts maintains and stores state information.

In the embodiment of FIG. 5, each of the hosts 16, 18, and 20 inform each of hosts 12 and 14 of the state of the hosts 16, 18, 20. In addition, host 12 informs hosts 14 of the state of host 12 and, similarly, host 14 informs host 12 of the state of host 14. Thus, in accordance with the example of FIG. 5, each of hosts 12 and 14 are informed of the state of all five hosts, but hosts 16, 18, and 20 are not informed of the states of all five hosts, or even necessarily any of the hosts. If one of the hosts 16, 18, and 20 fail, then either or both of the hosts 12 and 14, which have state information of all five hosts, can determine whether a merge operation needs to be performed as described above. If either of hosts 12 or 14 fail, then the remaining host 12 or 14 that is operational determines whether a merge operation is needed. Further, even those hosts that are operational and do not maintain state information (i.e., hosts 16, 18, 20) can also decide whether to perform a merge, but must first obtain the state information from either of hosts 12 or 14.

At a minimum, one host maintains state information for the system to determine whether a merge operation is needed upon a failure of a host. However, if only one host maintains state information and that particular host is the host that fails, then the system will not have the ability to determine whether a merge operation is needed as described above. In such embodiments, however, the system can react by always performing a merge operation if the only host that maintains state information is the host that fails. By having at least two hosts maintain state information, then if any one of the hosts fails, at least one host still remains to determine whether a merge operation is needed. The embodiment of FIG. 5 in which fewer than all hosts maintain state information advantageously results in less traffic on communication link 25 than the embodiment of FIG. 1 in which of the five hosts reports state information to each of the other hosts. The host(s) that are to maintain state information can be programmable or set by a system designer.

In some embodiments, each host maintains a PW/NPW state for the entire storage space in the case in which the storage subsystem operates as a single logical volume. In other embodiments, the storage subsystem is operated as multiple logical volumes. In these latter embodiments, each host maintains its own PW/NPW state separately relative to one or more, but not all, of the logical volumes. As such, the decision whether to perform a merge operation and the merge operation itself may be performed relative to one or more, but not all, of the logical volumes. For example, each state may be applied to a single logical volume and the merge operation decision and performance are effectuated relative to that single logical volume.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a plurality of computers coupled together and comprising a first computer and one or more other computers, each of said plurality of computers storing and maintaining state information; and
a storage subsystem coupled to each of said plurality of computers;
wherein said first computer reports to at least one other computer of a state associated with the first computer and, when said first computer fails, at least one other computer determines whether to cause a merge operation to be performed on said storage subsystem based on a last reported state of the first computer when the first computer fails, said merge operation ensuring data consistency on said storage subsystem.

2. The system of claim 1 wherein said first computer reports the state to the at least one other computer by transmitting a message to said at least one other computer, said message comprising a state indicator, said indicator being indicative of a pending write (“PW”) state and a no pending write (“NPW”) state, said PW state indicating that the first computer may perform a write to said storage subsystem and said NPW state indicating that the first computer will not perform a write to said storage subsystem.

3. The system of claim 1 wherein each plurality of computers comprises a state information data structure that is adapted to include state information of other computers in said system, said state information indicative of whether or not each of said computers is in a state to perform writes to said storage subsystem.

4. The system of claim 1 wherein at least one of said plurality of computers comprises a state information data structure that is adapted to include state information of at least one other computer in said system, said state information indicative of whether or not a computer associated with the state information is in a state to perform writes to said storage subsystem.

5. The system of claim 1 wherein said storage subsystem comprises a plurality of redundantly operable storage devices, each storage device coupled to each of said plurality of computers.

6. The system of claim 1 wherein the storage subsystem comprises a plurality of logical volumes and where the state reported by the first computer applies to one or more, but not all, of said logical volumes.

7. The system of claim 6 wherein the at least one other computer determines whether to cause a merge operation to be performed on one or more, but not all, of said logical volumes.

8. A system, comprising:
a plurality of computers coupled together and including a first computer, each of said plurality of computers storing and maintaining state information; and
a storage subsystem coupled to each of said plurality of computers;
wherein said first computer informs at least one other computer of a state associated with the first computer, the state being either a pending write (“PW”) state or a no pending write (“NPW”) state, said PW state indicative of the first computer being in a state to write data to said storage subsystem and said NPW state indicative of the first computer not being in a state to write data to said storage subsystem; and
wherein at least one of said plurality of computers determines whether to perform a merge of data on said storage system based on said PW or NPW state of the first computer.

9. The system of claim 8 wherein each of said plurality of computers informs each of the other computers of the PW or NPW state of the informing computer.

10. The system of claim 8 wherein at least one of said plurality of computers precludes a merge of data on said storage subsystem from occurring if a failed computer was in the NPW state upon its failure.

11. The system of claim 10 wherein said at least one computer causes a merge to occur if the failed computer was in the PW state upon its failure.

12. The system of claim 8 wherein each of at least two of said plurality of computers contains information as to the state of all other computers.

13. The system of claim 8 wherein the storage subsystem comprises a plurality of logical volumes and where the state reported by the first computer applies to one or more, but not all, of said logical volumes.

14. The system of claim 13 wherein the at least one of said plurality of computers determines whether to perform a merge of data on one or more, but not all, of the logical volumes.

15. A system, comprising:
a plurality of computers coupled together and comprising a first computer; and
a storage subsystem coupled to each of said plurality of computers;
wherein said first computer receives an indication from another computer of a state associated with said other computer, the state being either a pending write (“PW”) state or a no pending write (“NPW”) state, said PW state indicative of said other computer being in a state to permit writes to said storage subsystem and said NPW state indicative of said other computer being in a state to preclude writes to said storage subsystem.

16. The system of claim 15 wherein, after a failure of the other computer, the first computer ascertains the last received indication of the state of the other computer and determines whether to perform a merge operation of data in said storage subsystem based on the last received indication.

17. The system of claim 15 wherein the first computer precludes a merge from occurring if the last received state is the NPW state.

18. The system of claim 15 wherein the storage system comprises a plurality of logical volumes and the PW and NPW states apply to individual logical volumes.

19. The system of claim 18 wherein the first computer precludes a merge from occurring on a single logical volume if that logical volume is the NPW state.

20. A first computer adapted to communicate with another computer and to a redundant storage subsystem external to said first computer, comprising:
memory comprising state information; and
a processor that receives a state from said other computer, said state indicative of whether said other computer may perform write transactions to said redundant storage subsystem, and determines whether to perform a data merge operation on said redundant storage subsystem based on the other computer's last received state prior to a failure of the other computer.

21. The first computer of claim 20 wherein said software causes said processor to report to at least one other computer a state associated with said first computer, said state indicative of whether the first computer can write data to said redundant storage subsystem.

22. The first computer of claim 20 wherein said software causes said processor to receive the state of a plurality of other computers and, after one of the other computers fails, to determine whether to perform a merge operation based on the state last received from the failed computer.

23. The first computer of claim 22, wherein the software causes the processor to store the states of the other computers in a bitmap in said memory.

24. The first computer of claim 20 wherein the software causes the processor to preclude a merge operation from occurring if said state indicates said other computer was not writing data to said redundant storage subsystem.

25. The first computer of claim 20 wherein said storage subsystem comprises a plurality of logical volumes and wherein said received state pertains to one of a plurality of logical volumes of said storage system.

26. The first computer of claim 25 wherein the processor determines whether to perform a merge of data on one of the logical volumes.

27. A method implemented in a first computer, comprising:
upon a failure of another computer, searching through state information in the first computer, said state information indicative of whether at least one other computer was in a state permitting write transactions to a redundant storage subsystem to occur; and
determining whether to perform a merge process on a redundant storage subsystem based on said state information.

28. The method of claim 27 further comprising precluding the merge process from occurring if a computer that fails was in a state precluding write transactions to the redundant storage subsystem from occurring.

29. The method of claim 27 wherein determining whether to perform a merge comprises determining whether to perform a merge on one of a plurality of logical volumes of the redundant storage subsystem based on the state information which pertains separately to each logical volume.

30. A method, comprising:
if no write transactions are pending to be performed by a computer to a redundant storage subsystem, transmitting a message that indicates no write transactions will be performed;
detecting a failure of a computer;
precluding a merge process from occurring if said failed computer had transmitted said message.

31. The method of claim 30 further comprising permitting said merge process to occur if said message had not been transmitted.

32. The method of claim 30 wherein said message pertains to one or more, but not all, logical volumes and wherein precluding a merge process from occurring comprises precluding the merge process from occurring on a single logical volume based on said message.

33. A first computer adapted to communicate with another computer and to a redundant storage subsystem external to said first computer, comprising:
means for storing state information; and
means for receiving a state from said other computer, said state indicative of whether said other computer may perform write transactions to said redundant storage subsystem, and for determining whether to perform a data merge operation on said redundant storage subsystem based on the other computer's last received state prior to a failure of the other computer.

34. The first computer of claim 33 further comprising means for reporting to at least one other computer a state associated with said first computer, said state indicative of whether the first computer can write data to said redundant storage subsystem.
